(19) United States
(12) Patent Application Publication
(10) Pub. No.: US 2005/0243225 A1
(43) Pub. Date: Nov. 3, 2005

(54) Projector imaging apparatus with reflective mixed-mode twisted nematic liquid crystal panel

(75) Inventors: Peter J. Janssen, Scarborough, NY (US); Sergei Y. Yakovenko, Verplank, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijike Philips Electronics N.V., BA Eindhoven (NL)

(21) Appl. No.: 10/528,303

(22) PCT Filed: Sep. 16, 2003
(86) PCT No.: PCT/US03/29088

§ 371 Date: Mar. 17, 2005

(51) Int. Cl. G02F 1/1335

(52) U.S. Cl. 349/18

(57) ABSTRACT

An optical apparatus comprises a reflective liquid crystal (LC) panel, and an optical device. The LC panel includes a twisted-nematic (TN) LC material, wherein one mode of the LC material includes a 90 degree twist (90TN0). A color sequential light valve may incorporate the LC material with the 90 degree twist (90TN0). The LC panel beneficially exhibits a contrast of at least approximately 1000:1. Moreover the LC panel exhibits minimal divergence between transfer characteristics for different colors of the optical system. Furthermore, the LC panel provides a higher contrast and superior uniformity in both dark and bright states, compared to known LC devices. Finally, the use of retarders in LC-based systems may be minimized or eliminated using the LC panel.

Color sequential LC projection is an enabling technology for affordable high-definition (HD) television. One element that is useful to achieve the high performance required for this application is a high speed liquid crystal (LC) light valve, able to support the high frame rate necessary to avoid color sequential artifacts. In addition, the LC light valve must have a very high contrast ratio in order to compete with other technologies, like CRT or DLP.

Twisted LC modes that are presently being used require external compensation, such as light retarders. For compensation to work, it is necessary that the LC display be very uniform and stable over time and with varying environmental conditions. That has proved to be a relatively difficult task.

It would be advantageous to improve uniformity, reduce or eliminate the requirement for compensation, improve response speed and reduce manufacturing costs in color sequential and other LC projection systems. It would also be advantageous to have a design that is rather insensitive to cell gap variations, thus minimizing if not eliminating a major yield problem.

In accordance with an example embodiment, an optical apparatus comprises a reflective liquid crystal (LC) panel, and an optical device. The LC panel includes a twisted-nematic (TN) LC device, wherein one mode of the LC material includes a 90 degree twist (90TN0).

In accordance with another example embodiment, a color sequential light valve includes a TN LC device, wherein one mode includes a 90 degree twist (90TN0).

The LC device of an example embodiment beneficially exhibits a contrast of at least approximately 1000:1. Moreover the LC device of an example embodiment exhibits minimal divergence between transfer characteristics for different colors of the optical system. Furthermore, the LC device of an example embodiment provides a higher contrast and superior uniformity in both dark and bright states, compared to known LC devices.

The invention is best understood from the following detailed description when read with the accompanying drawing figures. It is emphasized that the various features are not necessarily drawn to scale. In fact, the dimensions may be arbitrarily increased or decreased for clarity of discussion.

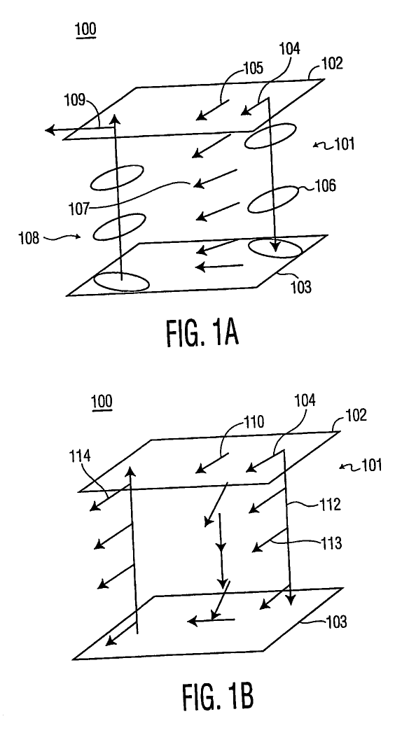

FIG. 1 is a conceptual view of an LC panel in accordance with an example embodiment.

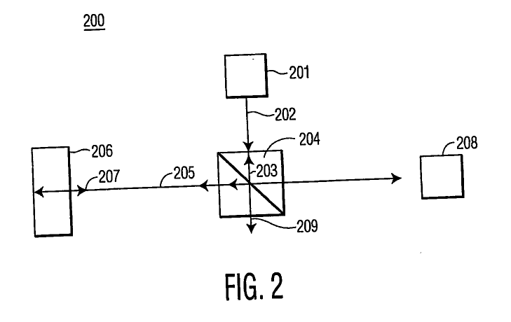

FIG. 2 shows a color sequential projection system in accordance with an example embodiment.

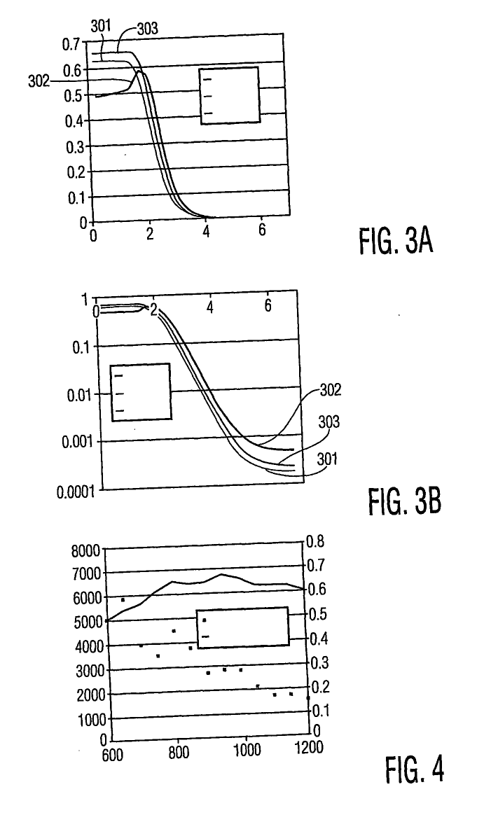

FIGS. 3A and 3B are graphical representations of the simulated reflectivity vs. voltage applied to an LC panel for 90TN0 for 3 colors in linear and logarithmic scales, respectively, and in accordance with an example embodiment.

FIG. 4 is a graphical representation showing maximal brightness and contrast for a 90TN0 LC panel (green state light) in accordance with an example embodiment.

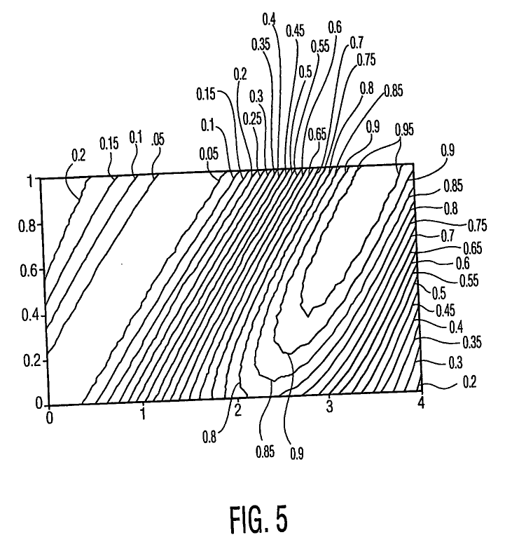

FIG. 5 illustrates reflectivity of 45TN0 in the OFF state versus normalized LC retardance 2πΔnd/λ (horizontal axis) and foil retardance (vertical axis).

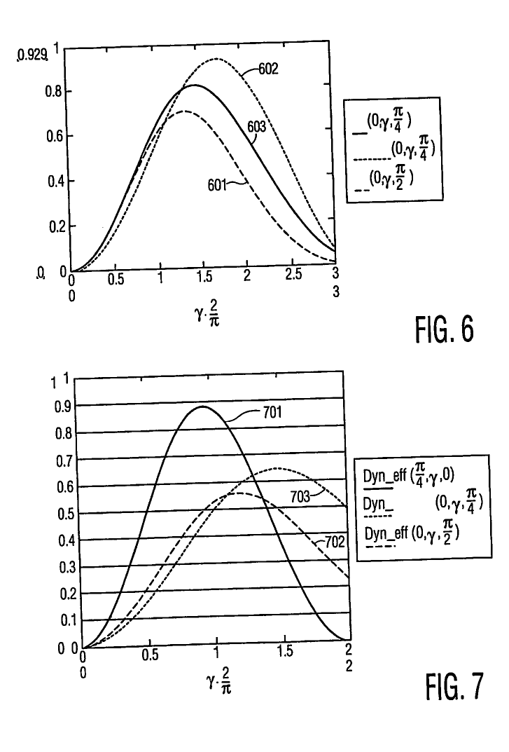

FIG. 6 illustrates reflectivity of 90TN0 of an example embodiment of a known 45TN0 device, with and without compensating foil as a function of normalized LC retardance (2πΔnd/λ).

FIG. 7 is a graphical representation of the reflectivity of a known quarter wave plate, a 90TN0 LC panel of an example embodiment and a known 45TN0 LC panel as a function of the LC retardance in the saturated color case using TL-216 as a liquid crystal material.

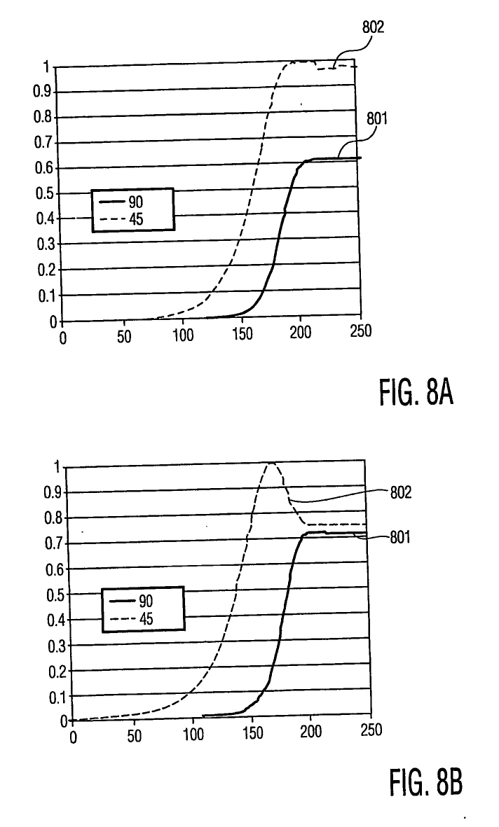

FIGS. 8A and 8B illustrate reflectivity (static, i.e., without black pre-write) vs. gray level curves for a 90TN0 LC panel of an example embodiment and a known 45TN0 LC panel, where the latter includes a 24 nm optical retarder.

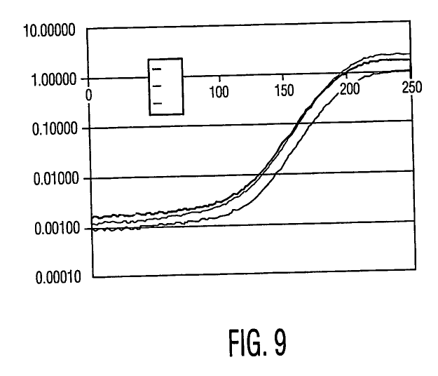

FIG. 9 illustrates reflectivity (dynamic, i.e., with 7 lines black pre-write) vs. gray level curves for a 90TN0 LC of an example embodiment for 3 colors.

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, example embodiments include an LC panel (device) having reflective 90 degree twisted nematic (90TN0) modes used in a color sequential environment and Illustratively, input light polarized parallel to one of the LC alignment directions, yields a dynamic bright state efficiency, which, when compared to other modes is acceptable, and all other characteristics are superior to known LC material-based devices.

FIG. 1a is a conceptual view of light traversing a section of a 90TN0 LC material 101 of an LC panel 100 in accordance with an example embodiment, in which no electric field is applied (OFF state) to the LC material. A glass plate 102 is disposed over a front surface of the LC panel 100 and a reflective surface 103 is disposed at a rear surface. Linearly polarized light having a polarization vector 104 is incident on the LC panel 100 and has an orientation that is parallel to the orientation vector 105 of the LC material 101.

The optically anisotropic property of the 90 TN0 LC material 101 results in a transformation of the polarization state of the light from the incident linear p-state 104 to various elliptical polarization states 106. This anisotropy results from a rotation in the orientation vector of the LC material 104 as shown by the orientation vectors 107. Upon reflection from the reflective surface 103, the polarization state of the light continues to change from on elliptical state to another (as shown as elliptical states 108), until upon emerging from the front surface 102, the polarization state is a linear state 108 that is rotated orthogonally relative to the incident linear polarization state 104.

FIG. 1b is a conceptual view of light traversing the section of 90 TN0 LC material 101 of the LC panel 100 in accordance with an example embodiment, in which an electric field is applied. This is referred to as the ‘ON’ state of the panel. Polarized light 104 is incident on the LC panel 100 as shown, and is oriented parallel with the orientation vector 110 of the LC material. Light 112 traverses the material 101, and the polarization vector 113 remains in its incident state. Upon reflection and traversal of the material in the reflected direction, the polarization state of the reflected light 114 is parallel to the incident polarized light. As can be appreciated, the on and off state of the LC material 101 can be used in light valve applications.

A color sequential projection system 200 in accordance with an example embodiment is shown in FIG. 2. A multi-color (e.g., RGB) light source 201 outputs light 202 to a polarization beam splitter (PBS) 204 or similar device. At least a portion of light 202 is redirected as light 205 by the PBS 204 to an LC panel 206, which includes a suitable 90 TN0 LC material. Conspicuously, there are no retarders, such as polarizers in the light path between the PBS 204 and the LC panel 206 by virtue of the properties of the 90 TN0 LC material of an example embodiment. Light traverses the LC panel twice as shown, is reflected as light 207 and is then incident on the PBS 204 again. Depending on the voltage applied to the LC panel, the polarization of light 205 may be altered, and the light may be redirected to the light source as at 203 or out of the system as at 209 (i.e., black state light), or may be transmitted to the system optics 208 (i.e., bright state light). As will be readily understood by one skilled in the art, the system 200 may include variations and modifications, yet remain in keeping with the system shown.

FIGS. 3A and 3B are graphical representations of the simulated reflectivity vs. voltage applied to an LC panel for 90TN0 for 3 colors in linear and logarithmic scales, respectively. A cell gap of 1000 nm was chosen for the 90 TN0 LC panel. The contrast ratios for red light 301, blue light 302 and green light 303 are 3480, 2790, 1230, respectively, for the LC panel in accordance with an example embodiment.

It can be seen that with respect to the bright state, the brightness-voltage (BV) curve for 90TN0 is less sensitive to cell gap variation than other LC modes. In the dark state of the 90TN0 LC panel of an illustrative embodiment, the BV curves in the dark state are very flat, which result in very uniform color of the dark state.

FIG. 4 is a graphical representation showing maximal brightness and contrast for a 90TN0 LC panel (green state light) in accordance with an example embodiment. To find the optimal cell gap for a 90TN, BV curves may be scanned and maximum and minimum brightness was determined for each BV curve. The cell gap used to produce the BV curves (presented in FIGS. 3A through 3B) was chosen somewhat larger than the optimum for green. This is because it is useful to optimize for the red rather than green color, since the lamp is red deficient in this example embodiment.

It is noted that the example 90TN0 LC panel is about 10% lower in brightness than a similar 90TN20 LC panel, but has about 5 times higher contrast. Comparisons with a typical 45TN0 LC panel are not straightforward because the latter uses retarders.

Contrast, which is an electro-optic (EO) effect is reduced by interfacial reflections in LC panels with modes other than 90 TN0 (e.g., 90 TN20), whereas 90TN0 is free of this phenomenon. These interfacial reflections are dependent on the particular design of the AR and IMITO coatings. Brightness, which is also an EO effect, is discussed more fully below.

The mechanisms of the polarization conversion are also different: retardance in the case of 45 TN0 LC devices, anisotropic reflection in the case of 90 TN20. In the simple case, when there is no reflection from IMITO, and the only reflection comes from the PI/LC panel interface the intensity of the reflected light with converted polarization (orthogonal to the incident one) can be estimated. Denoting amplitude reflection coefficients for the ordinary and extraordinary waves, Rₒ and Rₑ, respectively, the intensity reflection coefficient for light polarized at 20° from the optical axis of the LC can be represented as:
r_{⊥}=(R₀²+Rₑ²)sin²(20−arctg(Rₒ/Rₑ))

When nₒ=1.52, nₑ=1.73 and n_{PI}=1.62 (which results in minimal reflections at this interface), r⊥=0.00043. In this case the contrast ratio for a 90TN20 LC panel cannot be higher than 2300:1. Although this number seems to be high, r⊥ reduces the actual contrast of 90TN20 to values which are unacceptable in projection systems. The same conclusion is valid for 90TN45 with r⊥=0.00105. Therefore 90TN20 cannot be considered as a promising replacement for 45TN0. In the following 45TN0 and 90TN0 are compared.

Although different reflections affect contrast of 45TN0 LC panels, the cumulative effect of reflections is quite considerable and the resulting contrast of known 45TN0 LC panels is considerably lower than that of 90TN0 LC panel of an example embodiment. In the following description, monochromatic collimated light and a non-driven state is considered.

FIG. 5 illustrates reflectivity of 45TN0 in the OFF state versus normalized LC retardance 2πΔnd/λ (horizontal axis) and foil retardance (vertical axis), calculated using the polarization transfer matrix formalism. In FIG. 5 the brightness of the OFF state of 45TN0 is presented as a function of cell gap and retardance of the compensation foil. For λ=550 nm, maximal brightness in FIG. 4A corresponds to a normalized LC retardance value of 2.64, and that of the retarder −0.26.

It can be seen from FIG. 5 that for higher retardance values, the higher the reflectivity of 45TN0 material, reaching a maximum (nearly 1) at a normalized cell retardance above 3. However, in order to reach this maximum brightness a high retardance compensating foil is needed, and this significantly reduces contrast. To maximize contrast the retardance of the compensating foil is maintained at 10% of that of the liquid crystal layer and sacrifice (a few percent) brightness.

FIG. 6 illustrates reflectivity of 90TN0 (601) and 45TN0 with (602) and without (603) compensating foil as a function of normalized LC retardance (2πΔnd/λ). Retardance of the compensating foil is assumed to be 10% of the LC retardance. Maximal brightness of both electro-optic effects can be found from FIG. 6. In the static case the maximum brightness for a 45TN0 LC panel is about 94% and a 90TN0 LC panel of an example embodiment is about 68%.

To produce saturated colors and to eliminate color cross-talk, the LC panel must be driven to a black state before each color (black pre-write), after which it relaxes to the desired gray level. Relaxation to the bright state is exponential with a characteristic time proportional to the square of the cell gap d, which is determined by the retardance γ that is required for maximum brightness:
τ∝d² and γ=2πΔnd/λ

Light efficiency of the electro-optic effect for the dynamic case can be approximated by the product of the static reflectivity, as discussed above, and the integral η of the exponential relaxation to the bright state (both are functions of the LC retardance):
where T is exposure time for each color (T=1/180/3/1.05 s). Using the measured

$$η ( γ ) := \frac{1}{T} \cdot {\int }_{0}^{T} ( 1 - exp ( \frac{- t}{τ ( γ )} ) ) ⅆ t$$

relaxation time for TL-216 (1000 nm cell gap) τ=0.51 ms, and the equation above, one can find η and reflectivity for the dynamic (saturated color) case.

FIG. 7 is a graphical representation of the reflectivity of a quarter wave plate 701, 90TN0 LC 702 and 45TN0 LC 703 as a function of the LC retardance in the saturated color case using TL-216 as a liquid crystal material. It can be seen that, in case black pre-write is ON, reflectivity of a quarter waveplate (ECB mode) is only 87% of the ideal case. Compared to the quarter wave plate, the efficiencies of 45TN0 and 90TN0 are further reduced due to their larger cell gap (i.e., lower speed). The difference in cell gap brings the efficiency of the latter two closer together. As a result, the dynamic efficiency of 90TN0 is only 14% below that of 45TN0.

Electro-optical performance of a 90TN0 cell has been evaluated and compared with 45TN0 panels. It was found that 90TN0 performs almost according to the computer simulations, and has considerably higher contrast than 45TN0 (no polarization conversion of the light passed only through the retarder), exceeding 2000:1 in green. Brightness of 90TN0 in the static case, i.e., without black pre-write, is lower than expected from the simulations (62% of that of 45TN0 equipped with 24 nm compensation foil).

In panels used for evaluation the backplane was rubbed at 90° (instead of 45°) with respect to the counter electrode. According to the data, the average cell gap in this product is 1.35 μm. MLC-6261 (instead of TL-216) with 0.15% of ZLI-811 was filled into the cell to provide proper retardance for 90TN0 effect for this cell gap. Parameters of these liquid crystals can be seen in Table 2.

TABLE 2

| LC | TL-216 | MLC-6261 |
|---|---|---|
| K11 | 14.4 | |
| K22 | 9 | |
| K33 | 19.6 | |
| Parallel Dielectric Constant | 9.7 | 12.1 |
| Perpendicular Dielectric | 4.2 | 4.1 |
| Constant | | |
| n₀ | 1.526746 | 1.4991 |
| nₑ | 1.743498 | 1.6393 |
| Flow viscosity | 36 | 38 |
| Clearing temperature | 82 | 95 |

FIGS. 8A and 8B illustrate reflectivity (static, i.e., without black pre-write) vs. gray level curves for a 90TN0 LC panel (801) and 45TN0 LC panel (802), where the latter includes a 24 nm retarder. Reflectivity is normalized to the maximal value for 45TN0. BV curves were taken in single color projector with RGB color filters. The results with blue and green color filters are presented in FIGS. 8A and 8B, respectively, together with BV curves of a typical 45TN0 cell taken in similar conditions right after 90TN0 cell was measured.

Simulations show that in the static case the maximum brightness (polarization conversion efficiency) for 45TN0 at zero voltage is about 94% (for TL-216 this requires d=1100 μm). If electric bias is used to maximize brightness, brightness can be increased further (by increasing the cell gap and retarder retardance). For 90TN0 simulations show maximal brightness of approximately 68%. For TL-216 this requires 950 nm cell gap, while for MLC-6261 1330 nm should be optimal for green light. From FIGS. 8A and 8B one can see that actual brightness of 90TN0 relative to 45TN0 in green light is close to 60% in green light instead of 70%. Relative brightness of 90TN0 (compared to 45TN0) exceeds 70% only for blue light, which can be explained by too great of a cell gap in 45TN0 cell case. In general, the reasons for the lower brightness of the 90TN0 (compared to the simulations) is unclear and requires development of experimental method to monitor cell gap in situ as well as more experiments with variable birefringence of the liquid crystal.

Another deviation of experimental data compared to the simulations is the absence of the reflectivity hump in the BV curve of 90TN0. Simulations predict such a hump for blue light, although its height should be smaller than in 45TN0 case as compared with experimental observations in FIG. 8B. Apparently the absence of the hump cannot be caused by the smallness of the cell gap, or birefringence of the liquid crystal (otherwise efficiency of 90TN0 in blue should be much higher).

FIG. 9 illustrates reflectivity (dynamic, i.e., with 7 lines black pre-write) vs. gray level curves for a 90TN0 LC for 3 colors. Contrast ratios (RGB) are 1200, 2200, and 1150. When black pre-write is ON (FIG. 9) threshold of the 90TN0 BV curves shifts about 25 gray levels up (while for 45TN0 only a 5 gray level shift is observed with similar settings) evidencing slower response of MLC-6261 compared to TL-216 at the same temperature. A seven-line pre-write is not sufficient to change overall brightness of the cell (experimentally confirmed), but change the shape of the BV curve. It is believed that viscosity of TL-216 decreases very fast with temperature and although at room temperature TL-216 and MLC-6261 should provide similar response, at elevated temperature situation can be very different, especially because MLC-6261 has higher clearing temperature. Temperature variation of the LC parameters complicates optimization of the cell parameters and requires additional experimental work.

The example embodiments having been described in detail in connection through a discussion of exemplary embodiments, it is clear that modifications of the invention will be apparent to one having ordinary skill in the art having had the benefit of the present disclosure. Such modifications and variations are included in the scope of the appended claims.

1. An optical apparatus, comprising:
a reflective liquid crystal (LC) panel including a twisted-nematic (TN) LC material, wherein one mode of the material includes a 90 degree twist (90TN0); and
at least one optical device.

2. An optical apparatus as recited in claim 1, wherein optical apparatus is an optical projection system.

3. An optical apparatus as recited in claim 2, wherein the optical projection system is a color sequential LC projection system.

4. An optical apparatus as recited in claim 1, wherein the optical apparatus includes no optical compensators in optical connection with the LC panel.

5. An optical apparatus as recited in claim 4, wherein the optical compensators include optical retarders.

6. An optical apparatus as recited in claim 5, wherein the optical retarder is a polarizer.

7. An optical apparatus as recited in claim 3, wherein the color sequential LC projection system includes a polarizing beam splitter, a light source adapted to project red, blue and green light, and projection optics.

8. An optical system as recited in claim 1, wherein the LC panel provides a contrast of at least approximately 1000:1.

9. An optical system as recited in claim 1, wherein the LC panel provides a contrast ratio of approximately 1200:1 for red light, approximately 2200:1 for green light, and approximately 1150:1 for blue light.

10. A reflective liquid crystal (LC) panel, comprising a twisted-nematic (TN) LC material, wherein the mode of the LC device is a 90 degree twist (90TN0).

11. A reflective LC panel as recited in claim 10, wherein the LC panel provides a contrast of at least approximately 1000:1.

12. A reflective LC panel as recited in claim 10, wherein the TN LC panel provides a contrast ratio of approximately 1200:1 for red light, approximately 2200:1 for green light, and approximately 1150:1 for blue light.

13. A reflective LC panel as recited in claim 10, wherein the LC material has a thickness in the range of approximately 1000 nm to approximately 1350 nm.

14. A method of transmitting light selectively from a light source to a projection system, the method comprising:
providing a reflective liquid crystal (LC) panel including a twisted-nematic (TN) LC material, wherein one mode includes a 90 degree twist (90TN0).

15. A method as recited in claim 14, wherein an optical compensator is not provided.

16. A method as recited in claim 14, wherein the method includes providing a on-state electric field and an off-state electric field to the LC material to selectively alter the orientation of molecules of the LC material.

17. A method as recited in claim 16, wherein light incident on a first surface of the LC panel that is polarized parallel to the orientation of the molecules emerges in an orthogonal state of polarization to the incident light in the off state, and in a parallel state of polarization to the incident light in the off state.

18. A method as recited in claim 17, wherein the incident light is linearly polarized.

19. A method as recited in claim 17, wherein the light that emerges from the LC panel is linearly polarized.
